(19) United States
(12) Patent Application Publication
(10) Pub. No.: US 2012/0306205 A1
(43) Pub. Date: Dec. 6, 2012

(54) NOVEL SYSTEMS FOR INCREASING EFFICIENCY AND POWER OUTPUT OF IN-CONDUIT HYDROELECTRIC POWER SYSTEM AND TURBINE

(75) Inventors: Mark Rydell Cosby, Goshen, IN (US); Timothy P. Braun, Cassopolis, MI (US); Roderic Alan Schlabach, Goshen, IN (US); Igor Palley, Madison, NJ (US); Jacob J. Brenneman, Goshen, IN (US); Joshua T. Thomas, Goshen, IN (US)

(73) Assignee: Lucid Energy, Inc., Portland, OR (US)

(21) Appl. No.: 13/353,317

(22) Filed: Jan. 19, 2012

Related U.S. Application Data
(60) Provisional application No. 61/493,937, filed on Jun. 6, 2011.

(51) Int. Cl. F04D 17/06; B21K 25/00; H02K 7/18; F03B 3/00; F03D 3/04

(52) U.S. Cl. 290/52; 416/177; 415/53.1; 415/74; 29/889.2

(57) ABSTRACT

Inventive systems (e.g., turbines) for harnessing hydroelectric energy are described. The turbines, includes: (1) a central longitudinal shaft configured to mount and to rotate on a central axis perpendicular to a direction of fluid flow; (2) a plurality of arcing blades coupled with the shaft, the blades extending radially outwardly from the shaft, and the blades including an airfoil cross-section along a substantial length of the blades; and (3) a hydrodynamic cap covering a location where the arcing blades couple with the shaft such that in an operating state of the turbine, presence of the hydrodynamic cap reduces an amount of bypass area, which is area outside a region that is swept by the arcing blades.

### RELATED APPLICATION

The application claims priority from U.S. Provisional Application having Serial No. 61,493,937, filed on Jun. 6, 2011, which is incorporated herein by reference for all purposes.

### FIELD OF THE INVENTION

The present invention relates generally to turbine assemblies useful for harnessing hydroelectric energy. More particularly, the present invention relates to improved fluid flow past turbine assemblies that provide increased efficiency and power output at a given flow rate.

### BACKGROUND OF THE INVENTION

Hydroelectric energy refers to the generation of energy from a flow current or velocity of water. This type of energy is different from hydroenergy, which traditionally refers to power generated using dams (impoundment or run-of-river). Because hydroelectric energy relies on the velocity of water, these energy systems can be placed into sources of flowing water with minimal infrastructure or environmental impacts. As a result, hydroelectric power is considered cutting-edge waterpower.

FIG. 1 shows a side-sectional view of a conventional in-conduit turbine assembly 100 for generating hydroelectric energy. Assembly 100 has a spherical turbine assembly 128 disposed inside conduit 118 with a flange 112 disposed on one end of conduit 118. Turbine assembly 128 has spherical turbine blades 114 attached to a hub plate 122 via saw-tooth mounts 116. Not shown to simplify illustration, turbine assembly 128 has a shaft disposed along a vertical axis, which travels through the poles of turbine assembly 128 and through apertures defined on opposite sides of conduit 118.

When assembled and driven by fluid flow through conduit 118, turbine assembly 128 rotates with a shaft to which it is coupled, and, when connected to a power generator (not shown to facilitate illustration and discussion), produces electric power that can be stored, consumed, or fed into a power grid. A portion of the fluid flow through conduit 118, however, does not drive rotation of turbine assembly 128, but rather, flows through bypass area 120, which is located between the outer periphery of the blade-swept area of turbine assembly 128 (including the region above and below the turbine assembly) and the inner surface of conduit 118.

Unfortunately, the conventional in-conduit turbine assembly suffers from drawbacks. By way of example, bypass area 120 allows a certain amount of fluid to flow around the turbine instead of through it, causing a decrease in power output at a given flow rate. As another example, frequently there are drag loses due to the exposure of the surface of mounts 116 and other locations e.g., where blades 114 mount to hub plate 122. This drawback is exacerbated particularly when a saw-tooth design of mounts 116 is employed. As a result, bypass area 120 in conventional in-conduit turbine designs provides a path for fluid to flow past certain features of the turbine assembly, e.g., where blades 114 mount to saw-tooth mounts 116, causing an increase in drag of fluid flow, and consequently, a decrease in efficiency of the turbine.

What is therefore needed are improved systems and methods of assembling turbine assemblies that do not suffer from the drawbacks encountered by their counterpart conventional designs.

### SUMMARY OF THE INVENTION

In view of the foregoing, in one aspect, the present invention provides novel systems and methods for increasing efficiency and power output of in-conduit hydroelectric power systems and turbines.

In one aspect, the present invention discloses a turbine. The turbine includes: (1) a central longitudinal shaft configured to mount and to rotate on a central axis perpendicular to a direction of fluid flow; (2) a plurality of arcing blades coupled with the shaft, with the blades extending radially outwardly from the shaft, and the blades including an airfoil cross-section along a substantial length of the blades; and (3) a hydrodynamic cap covering a location where the arcing blades couple with the shaft such that in an operating state of the turbine, the presence of the hydrodynamic cap reduces an amount of bypass area, which is an area outside a region that is swept by the arcing blades. Preferably, the hydrodynamic cap forces a larger amount of liquid to flow through the region that is swept by the arcing blades than if the hydrodynamic cap was absent.

In one embodiment of the present invention, the blades are evenly spaced around said shaft. Preferably, the angle between the plane defined by each of the blades and the central axis of the shaft is between about 10° and about 45°.

In certain embodiments of the present invention, the hydrodynamic cap is disposed above the location where the arcing blades couple with the shaft. In alternate embodiments, the hydrodynamic cap is disposed below the location where the arcing blades couple with the shaft. Preferably, the turbine includes opposing hub assemblies, each including a hub plate and a plurality of mounting brackets for securely coupling opposite ends of the plurality of blades to the shaft. In such embodiments, the turbine includes two opposing hydrodynamic caps, each covering one of the hub assemblies.

In preferred embodiments of the present invention, the hydrodynamic cap is made from at least one material selected from a group consisting of plastic, metal, composite material and alloy. The composite material may include resin-impregnated fiberglass or resin-impregnated fiber. In certain embodiments, the inner surface of the hydrodynamic cap has a radius of curvature that is substantially equal to the radius of curvature of the turbine. Preferably, the hydrodynamic cap has an angular distance that is between about 25° and about 60°, wherein an equator of the turbine is at an angular distance of 90°. The poles, which are located at an outermost location of the turbine that is perpendicular to the equator, have an angular distance of 0°. In preferred embodiments of the present invention, the hydrodynamic cap has an aperture defined therein to allow the shaft to pass through the aperture of the hydrodynamic cap, and the aperture is at a location that is perpendicular to the equator of the turbine.

In another aspect, the present invention discloses a turbine. The turbine includes: (1) a central longitudinal shaft configured to mount and to rotate on a central axis perpendicular to a direction of fluid flow; (2) a plurality of arcing blades coupled with the shaft, the blades extending radially outwardly from the shaft, and the blades including an airfoil cross-section along a substantial length of the blades; and (3) wherein the turbine has a diameter that scales with an inner diameter of a conduit, inside which the turbine is installed for generating power, such that a clearance created between the inner sidewall of the conduit and an outermost surface of the turbine, when the turbine is installed in the conduit, ranges from about 0.5% to about 2% of the outermost diameter of the turbine. Preferably, the clearance between the inner sidewall of the conduit and the outermost surface of the turbine is between about 0.5% and 1% of the outermost diameter of the turbine.

In yet another aspect, the present system discloses a power generating system that generates power from the movement of fluids. The system includes: (1) a turbine, which includes: (a) a central longitudinal shaft configured to mount and to rotate on a central axis perpendicular to a direction of fluid flow; (b) a plurality of arcing blades coupled with the shaft, the blades extending radially outwardly from the shaft, and the blades including an airfoil cross-section along a substantial length of the blades; and (c) a hydrodynamic cap covering a location where the arcing blades couple with the shaft such that in an operating state of the turbine, presence of the hydrodynamic cap forces a larger amount of liquid to flow through a region that is swept by the arcing blades of the turbine than if the hydrodynamic cap was absent; and (2) a generator operatively coupled with the shaft such that when fluid flows through the turbine, the blades and the shaft rotate around the central axis causing the generator to produce electricity. Preferably, the generator provides an increase in power efficiency that is less than or equal to about 30% in the presence of the hydrodynamic cap, as opposed to when the hydrodynamic cap is absent.

In yet another aspect, the present invention discloses a process for manufacturing a power generating system customized for an application. The process includes: (1) obtaining a power requirement for the application; (2) determining dimensions of a turbine and a hydrodynamic cap that are capable of providing the power requirement for the application; (3) coupling a plurality of blades and a shaft to form a turbine having these dimensions; (4) installing the turbine system in a conduit; and (5) operatively coupling a generator subassembly to the turbine system and producing the power generating system. Preferably, determining includes referring to a lookup table, which contains various predetermined values for dimensions of the turbine and for the hydrodynamic cap that correspond to certain predetermined power requirements.

In preferred embodiments of the present invention, the process for manufacturing a power generating system customized for an application includes the further steps of: (1) obtaining a hydrodynamic cap of these dimensions; and (2) assembling the hydrodynamic cap and the turbine to form a turbine system.

### BRIEF DESCRIPTION OF THE DRAWINGS

FIG. 1 is a side-sectional view of a conventional in-conduit turbine assembly for generating hydroelectric energy.

FIG. 2 is a side-sectional view of an in-conduit turbine assembly, according to one embodiment of the present invention, which uses a hydrodynamic cap for effectively generating hydroelectric energy.

FIG. 3 is a partial exploded view of some major components of the inventive in-conduit turbine assembly shown in FIG. 2.

FIG. 4A is a side-sectional view of a hydrodynamic cap, shown in FIG. 2, and disposed above the blade-swept area of a spherical turbine.

FIG. 4B shows a magnified view of a thickness of the hydrodynamic cap of FIG. 4A.

FIG. 5 is a side-sectional view of an in-conduit turbine assembly, according to an alternate embodiment of the present invention, for generating hydroelectric energy.

FIG. 6 is a power generating system, according to one embodiment of the present invention, which generates power from fluid flow.

### DETAILED DESCRIPTION OF THE PREFERRED EMBODIMENTS

In the following description, numerous specific details are set forth in order to provide a thorough understanding of the present invention. It will be apparent, however, to one skilled in the art that the present invention is practiced without limitation to some or all of these specific details. In other instances, well-known process steps have not been described in detail in order to not unnecessarily obscure the invention.

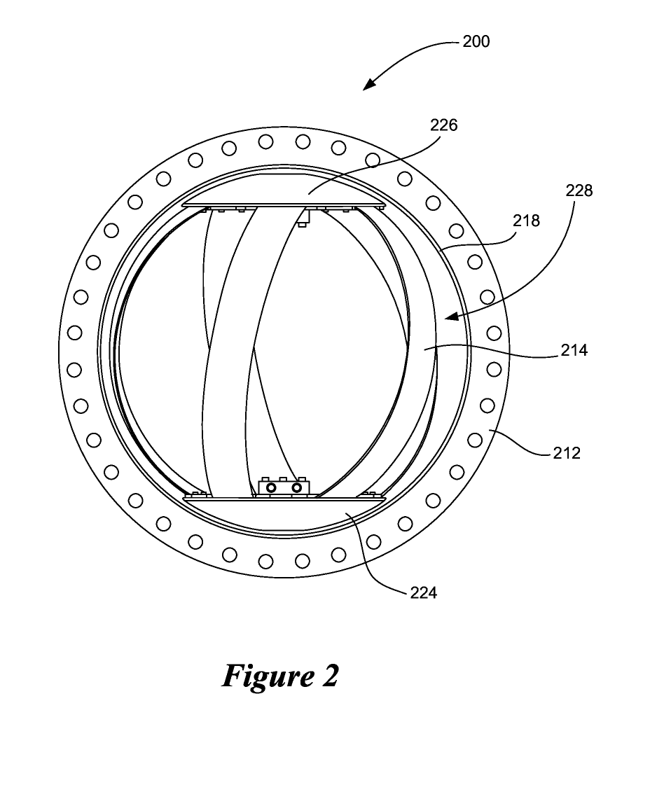

FIG. 2 shows a side-sectional view of an inventive in-conduit turbine assembly 200, according to one embodiment of the present invention, for generating hydroelectric energy. In-conduit turbine assembly 200 includes a turbine assembly 228 disposed inside a conduit 218 with flange 212 disposed on one end of conduit 218.

Turbine assembly 228 includes arced turbine blades 214, which are attached to a hub plate via mounts, which are not shown to facilitate illustration and discussion. During turbine operation, arcing blades 214 rotate, preferably sweeping a substantially spherical shape, around a central longitudinal shaft (not shown to facilitate illustration and discussion), which is disposed perpendicular to a direction of fluid flow through conduit 218. Turbine assembly 228 of FIG. 2 includes one or more hydrodynamic caps (i.e., denoted by reference numerals 224 and 226) to reduce a bypass area 220 between blade-swept area of turbine assembly 228 (including the top and bottom of the turbine assembly) and inner surface of conduit 218.

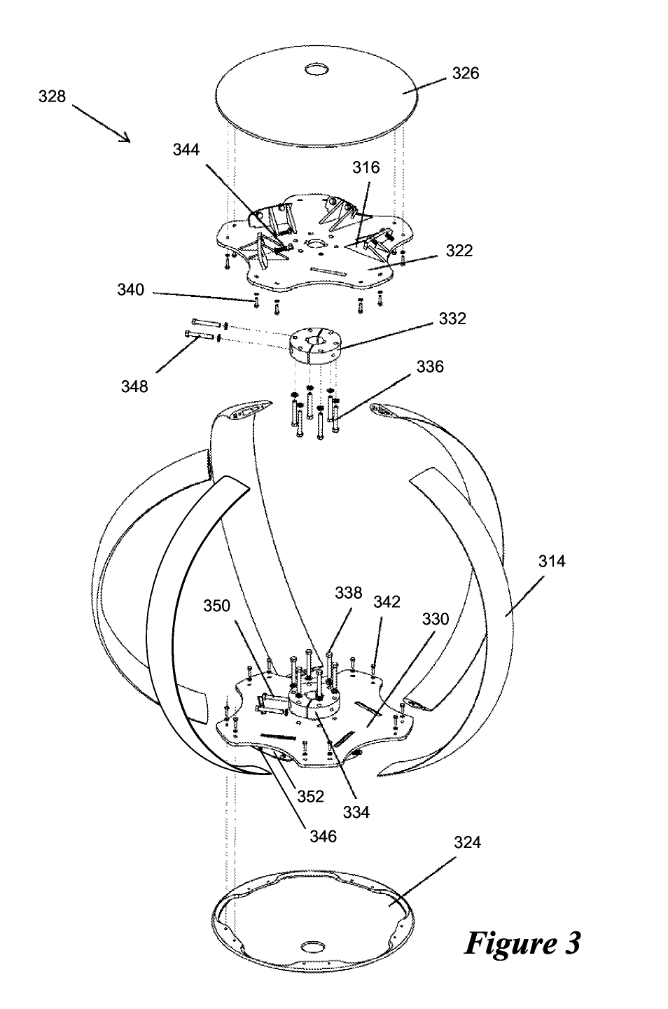

Hydrodynamic caps 224 and 226 are attached to a first end and a second end, respectively, of turbine assembly 228. As will be explained later in reference to FIG. 3, hydrodynamic caps 224 and 226 are attached to the same hub plates as each end of the respective ends of blades 214.

The presence of hydrodynamic caps 224 and 226 of the present invention forces a larger amount of fluid, for a given or fixed fluid flow rate through a conduit, to flow through turbine assembly 228 or a region that is swept by blades 214 than would if the hydrodynamic caps were absent, and consequently, a lesser amount of fluid flows through bypass area 220. Stated another way, the presence of hydrodynamic caps 224 and 226 forces a larger amount of fluid to flow through the centerline plane of conduit 218 or through the centerline plane of blade-swept area of turbine assembly 228 than if the hydrodynamic caps were absent. Furthermore, those skilled in the art will recognize that for a given or fixed fluid flow rate through a conduit, the presence of hydrodynamic caps provides for a greater average fluid velocity through turbine assembly 224 and 226, or, in the alternate, through the centerline plane of turbine assembly 228.

Those skilled in the art will recognize that a single hydrodynamic cap may be uses in a turbine assembly design of the present invention to reduce the bypass area, but that use of two hydrodynamic caps represents a preferred embodiment of the present invention.

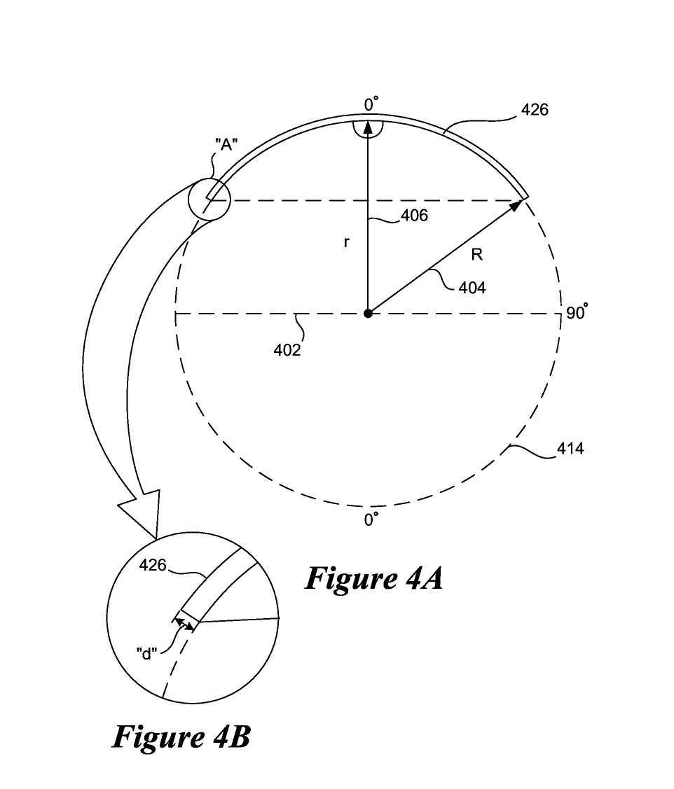

Regardless of whether one or two hydrodynamic caps are used, forcing more water through the area swept by blades 214 translates into higher power generation from the turbine assemblies of the present invention. In those instances, where the average fluid velocity through the centerline of the turbine assembly is being monitored, the increase in power output can be thought to coincide with an increase in “tip speed ratio.” Tip speed ratio refers to the ratio of the speed of the blade (e.g., blades 214 of FIG. 2) at the centerline plane (as described with respect to FIG. 4A below) of the turbine assembly to the average velocity of fluid through conduit 218. In other words, for a given value of fixed fluid flow rate through a conduit, a reduction in bypass area 220 increases the tip speed ratio, and in turn, increases the power output and efficiency of the inventive turbine assemblies.

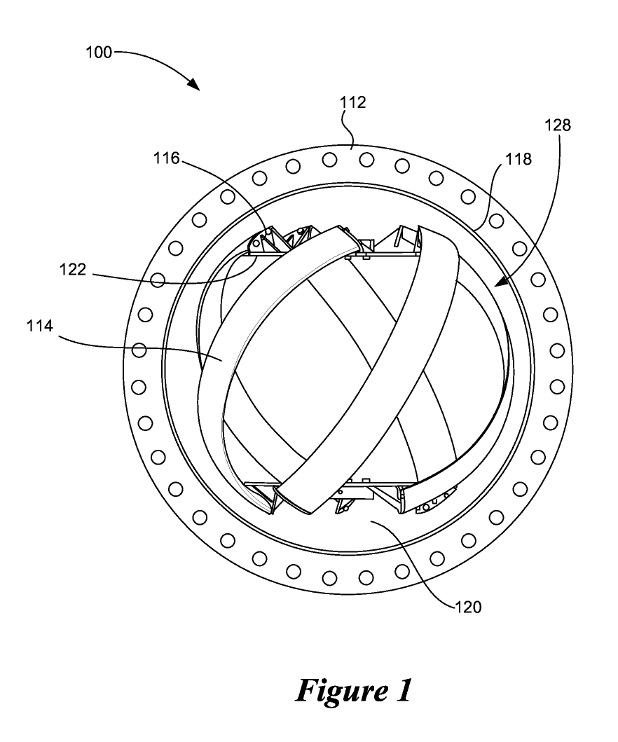

In addition to increasing power output and efficiencies by forcing a larger amount of fluid through the operating turbine assemblies, hydrodynamic caps 224 and 226 realize the same advantages of increased power output and efficiency by reducing drag loses. Specifically, hydrodynamic caps 224 and 226 conceal protruding features (e.g., presence of saw-tooth mounts 116 and/or connection points of blades 114 and hub plate 122 of FIG. 1). In other words, smoother ends in the turbine assemblies of the present invention reduce drag losses encountered in conventional turbine designs.

FIG. 3 shows an exploded view of an inventive turbine assembly 328, according to one embodiment of the present invention. The exploded view of turbine assembly 328 shows some of the major components of turbine assembly 228 shown in FIG. 2. Near top of turbine assembly 328, blades 314 attach to upper saw-tooth mounts 316 using bolts 344. Upper saw-tooth mounts 316 are located on an upper hub plate 322. In this manner, blades 314 are connected to upper hub plate 322. Also connected to hub plate 322 is an upper hydrodynamic cap 326. As shown in FIG. 3, bolts 340 accomplish this connection. An upper split shaft coupler 332 is attached to a bottom side of upper hub plate 322 using bolts 336. Furthermore, upper split shaft coupler 332 is also securely affixed using bolts 348 to a shaft (which is not shown to simplify illustration). As a result, split shaft coupler 332 and associated bolts 348 function to hold in place the rotating shaft during turbine operation.

Bottom end of blades 314, lower saw-tooth mounts 346, bolts 352, lower hub plate 330, lower hydrodynamic cap 324, bolts 342, lower split shaft coupler 334, and bolts 338 are substantially similar to and are present in substantially the same configuration as their counterparts in the upper portion of the inventive turbine assembly shown in FIG. 3.

Turbine assembly 328 has blades 314 spaced, preferably evenly, around a shaft. In preferred embodiments of the present invention, the angle between the plane defined by each of blades 314 and the central axis of a shaft is between about 10° and about 45°. In certain embodiments, blades 314 extend such that a plane defined by them is not parallel to a shaft. Preferably, blades 314 extend radially outwardly from a shaft, with the blades having an airfoil cross-section along a substantial length of the blades.

While FIG. 3 shows four arcing blades 314, the present invention contemplates the use of any plurality of blades. Depending on the number of blades in the plurality and their individual configuration and pitch, the plurality of blades defines a nominal solidity that is preferably between about 15% and about 45%. Blades 314 are composed of any rigid material that does not absorb water or any other fluid used to generate energy. In preferred embodiments of the present invention, blades are made from at least one material selected from a group consisting of aluminum, a suitable composite and a suitable reinforced plastic material.

Preferably, hydrodynamic caps 324 and 326 are made from a rigid, waterproof material, which includes at least one material selected from a group consisting of metal, plastic, composite material and alloy. The composite material may include resin-impregnated fiberglass or resin-impregnated fiber. In preferred embodiments of the present invention, the hydrodynamic cap has an aperture defined therein to allow a shaft to pass therethrough at a location that is perpendicular to a centerline plane of the inventive turbine assemblies.

Other components of turbine assembly 328, such as hub plates 322 and 330 and their respective saw-tooth mounts, upper and lower split shaft couplers 332 and 334 and the various bolts connections, are made from any rigid material. In preferred embodiments of the present invention, however, they too are made from the waterproof materials described above in connection with the hydrodynamic caps.

In alternate embodiments, turbine assemblies of the present invention include one or more mounting brackets for securely coupling opposite ends of blades to a shaft. In other embodiments of the present invention, hub plates do not include saw-tooth mounts to facilitate a connection between the hub plate and the blades. In these embodiments, fastening techniques or designs well known to those skilled in the art are used.

FIG. 4A is a side-sectional view of a hydrodynamic cap 426, according to one embodiment of the present invention, disposed above blade-swept area 414 of a turbine assembly, such as the one shown in FIG. 2. In preferred embodiments of the present invention, the radius of blade-swept area 414 (labeled “R” and denoted by reference numeral 404) is substantially equal to the radius of curvature (labeled “r” and denoted by reference numeral 406) of the inner surface of hydrodynamic cap 426. Radius 406 marks an angular distance of 0° on a circular blade-swept area 414 and is the position through which a shaft (not shown to simplify illustration) is disposed. An angular distance of 90° represents a centerline plane of blade-swept area 414, and is also referred to as the equator of blade-swept area 414. The equator of blade-swept area 414 of FIG. 4A is substantially similar to an equator of turbine assembly 228 of FIG. 2, and also substantially similar to an equator of conduit 218 of FIG. 2. In preferred embodiments of the present invention, hydrodynamic cap 426 conforms to the shape of the turbine's blade-swept area 414, and is therefore substantially dome shaped.

It is important to note that although the dome shape of the hydrodynamic cap provides the advantages of higher power output and efficiency, it may also cause undesired head loss during fluid flow. If the hydrodynamic cap is designed too large, such that a significant portion of an end of the turbine assembly is covered to reduce the bypass area, a significant increase in fluid flow rate through the turbine is realized at the expense of undesired head loses in fluid flow through a conduit. Conversely, if a hydrodynamic cap is designed too small, such that a significant portion of an end of the turbine assembly is uncovered (exposing a large bypass area for fluid flow), a reduction in head loss is realized at the expense of lower power output and efficiency for the operating turbine. As a result, the present invention recognizes that when selecting appropriate dimensions for the hydrodynamic cap, it is important to strike a balance between dimensions that provide an increased power output and efficiency, and dimensions that do not unduly adversely impact head loss of fluid flow through the conduit. To this end, hydrodynamic caps of varying sizes may be used in the inventive in-conduit applications of the present invention. An angular distance of hydrodynamic cap along a blade-swept area is a value between about 25° and about 60°, preferably between about 30° and about 50°, and more preferably a value of about 40°.

FIG. 4B shows a magnified portion of view “A” of FIG. 4A. FIG. 4B shows the thickness of hydrodynamic cap 236 (denoted by “d”). In accordance with one embodiment of the present invention, “d” is a value that is between about ⅛″ and about ½″. Preferably, however, “d” is about 0.25% to 2% of the radius of curvature of the blade-swept area.

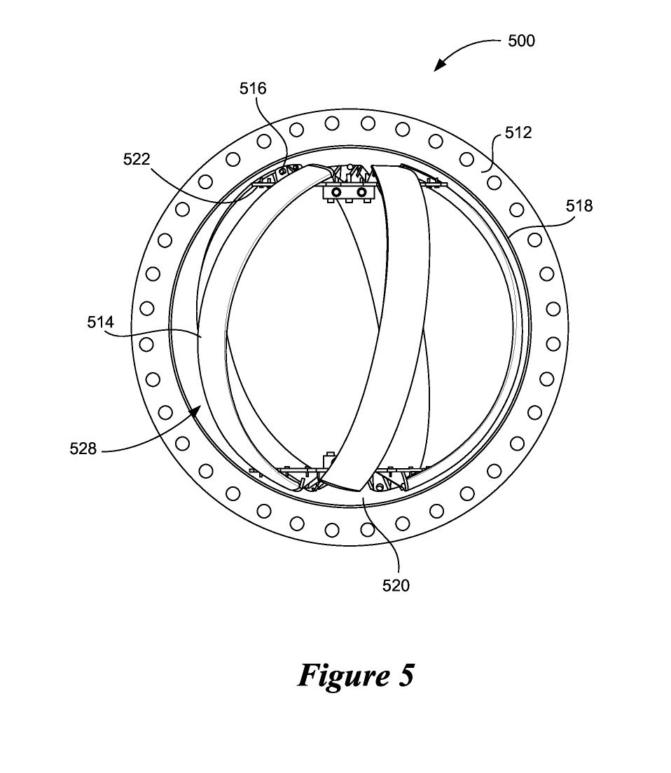

FIG. 5 shows an inventive in-conduit turbine assembly 500, according to an alternate embodiment of the present invention, which reduces a bypass area without implementing a hydrodynamic cap. Conduit 518, flange 512, turbine blades 514, bypass area 520, and turbine assembly 528 are substantially similar to their counterparts, conduit 218, flange 212, turbine blades 214, bypass area 220, and turbine assembly 228, shown in FIG. 2. Saw-tooth mounts 516 and hub plate 522 are substantially similar to their counterparts, saw-tooth mounts 316 and hub plate 322, of FIG. 3.

In this embodiment, blade-swept area of turbine assembly 528 is large enough to reduce the bypass area of fluid flow encountered in conventional turbine designs. In other words, in this embodiment, relatively large diameter of a blade-swept area of the inventive turbine assemblies scales with inner diameter of conduit 518. A clearance created between the blade-swept area of the turbine assembly and an inner surface of a conduit is a value that is between about 0.5% and about 2% of the blade-swept area of the turbine assembly, and preferably between about 0.5% and about 1% of the blade-swept area of the turbine assembly.

Although the embodiment shown in FIG. 5 does not utilize a hydrodynamic cap, certain preferred embodiments, which implement the embodiment of FIG. 5, may also use a hydrodynamic cap to further increase the power output and efficiency of the present invention. By utilizing a turbine assembly that scales more closely with the inner dimensions of a conduit, the present invention realizes a greater volume of fluid flow through an operating turbine for a given value of fluid flow rate through the conduit. In doing so, the present invention further realizes greater power outputs and efficiencies than the conventional turbine assemblies.

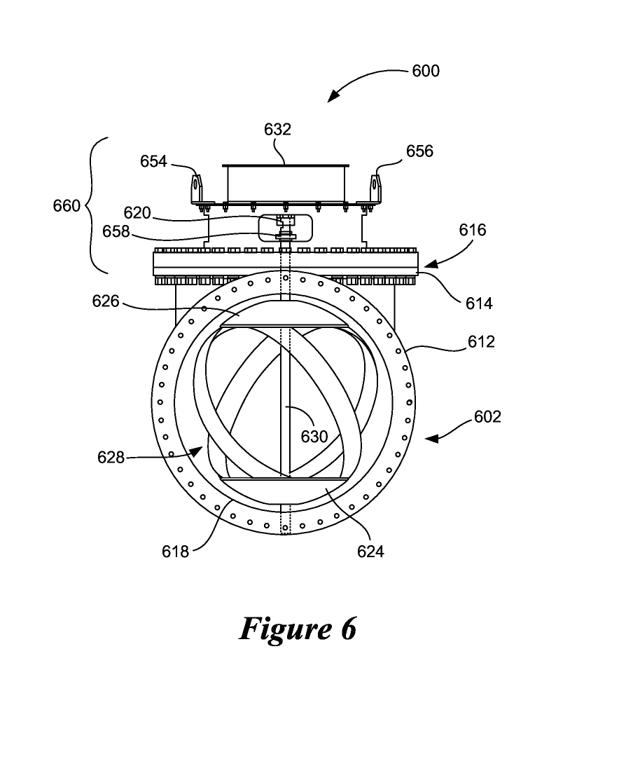

FIG. 6 shows a side-sectional view of a power generating system 600, which generates power from fluid flow through in-conduit turbine assembly 602. The inventive system of FIG. 6 includes a generator assembly 660 coupled to a turbine assembly 628. Turbine assembly 628 is substantially similar to turbine assembly 228 shown in FIG. 2. Hydrodynamic caps 624 and 626 of FIG. 6 appear in substantially the same configuration as hydrodynamic caps 224 and 226 of FIG. 2. However, turbine assembly 628 shows a shaft 630 disposed perpendicular to the direction of fluid flow inside a conduit 618, which has a flange 612 disposed on one end.

A generator assembly 660 is disposed atop turbine assembly 628 as shown in FIG. 6. Specifically, a flat surface is formed by a cover plate 616, which is coupled to flange 614 of conduit 618. At the end of shaft 630, a mount 658 is attached, which is disposed beneath a generator 620. Generator 620 will be understood to mount to, for rotation with, the distal end of shaft 630. Preferably, generator 620 provides an increase in power efficiency that is less than or equal to about 30% in the presence of hydrodynamic caps, as opposed to when a hydrodynamic cap is absent. Generator 620 can be direct or alternating current (DC or AC) and a single-phase or 3-phase, synchronized 120 VAC or 240 VAC, etc., and/or can be converted from one to the other, depending upon the power grid requirements. A cap 632 covers the generator assembly.

As shown in FIG. 6, an annular rim with a first mechanical lift tab 654 and a second mechanical lift tab 656 attached at each end is disposed above generator 620. Tabs 654 and 656 provide convenient tabs for lifting all or part of the assembled electrical power generation components during assembly, disassembly or maintenance.

In certain embodiments, with reference to the above-described systems, the present invention provides a process for manufacturing a power generating system customized for an application. To that end, a first step involves obtaining a power requirement for the application. A next step includes determining the dimensions of a turbine and, preferably, a hydrodynamic cap if one or more are to be used to reduce the bypass area. The turbine and/or hydrodynamic cap are sized to meet the power requirements for the application. Preferably, determining the turbine and/or hydrodynamic cap dimensions is carried out by referring to a lookup table that correlates values for the dimensions of the turbine and/or hydrodynamic cap to values of power requirements.

Having established the dimensions of a turbine and/or hydrodynamic cap, the assembly processes of the present invention preferably proceeds to steps that involve assembling the various turbine components. A plurality of blades and a shaft are coupled to provide the dimensions necessary for the power requirement of the application. Next, a step of installing the turbine system inside a conduit is carried out. Finally, a generator subassembly is operatively coupled to the turbine system to form a power generating system customized for a specific application.

In those embodiments where it is necessary to use a hydrodynamic cap, processes of the present invention further include obtaining one or more hydrodynamic caps and incorporating one or more hydrodynamic caps into the turbine assembly design as shown in FIG. 3.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A turbine, comprising:
a central longitudinal shaft configured to mount and to rotate on a central axis perpendicular to a direction of fluid flow;
a plurality of arcing blades coupled with said shaft, said blades extending radially outwardly from said shaft, and said blades including an airfoil cross-section along a substantial length of said blades; and
a hydrodynamic cap covering a location where said arcing blades couple with said shaft such that in an operating state of said turbine, presence of said hydrodynamic cap reduces an amount of bypass area, which is area outside a region that is swept by said arcing blades.

2. The turbine of claim 1, wherein said hydrodynamic cap forces a larger amount of liquid to flow through said region that is swept by said arcing blades.

3. The turbine of claim 1, wherein said blades are evenly spaced around said shaft.

4. The turbine of claim 1, wherein said blades extending such that a plane being defined by them is not parallel to said central axis.

5. The turbine of claim 4, wherein the angle between the plane defined by each of said blades and said central axis of said shaft is between about 10° and about 45°.

6. The turbine of claim 1, wherein in an operating state of said turbine when blades rotate with said shaft, said blades sweep a spherical shape.

7. The turbine of claim 1, wherein said hydrodynamic cap is disposed above said location where said arcing blades couple with said shaft.

8. The turbine of claim 1, wherein said hydrodynamic cap is disposed below said location where said arcing blades couple with said shaft.

9. The turbine of claim 1, further comprising opposing hub assemblies, each including a hub plate and a plurality of mounting brackets for securely coupling opposite ends of said plurality of blades to said shaft.

10. The turbine of claim 9, further comprising two opposing hydrodynamic caps, each covering one of said hub assemblies.

11. The turbine of claim 1, wherein said hydrodynamic cap is made from at least one material selected from a group consisting of plastic, metal, composite and alloy.

12. The turbine of claim 11, wherein said composite includes resin-impregnated fiberglass or resin-impregnated fiber.

13. The turbine of claim 1, wherein said inner surface of said hydrodynamic cap has a radius of curvature that is substantially equal to said radius of curvature of said turbine.

14. The turbine of claim 1, wherein said hydrodynamic cap has an angular distance that is between about 25° and about 60°, wherein an equator of said turbine is at an angular distance of 90° and poles, which are an outermost location of said turbine that is perpendicular to said equator, have an angular distance of 0°.

15. The turbine of claim 1, wherein said hydrodynamic cap has an aperture defined therein to allow said shaft to pass through said aperture of said hydrodynamic cap and said aperture is at a location that is perpendicular to said equator of said turbine.

16. A turbine, comprising:
a central longitudinal shaft configured to mount and to rotate on a central axis perpendicular to a direction of fluid flow;
a plurality of arcing blades coupled with said shaft, said blades extending radially outwardly from the shaft, and said blades including an airfoil cross-section along a substantial length of said blades; and
wherein said turbine has a diameter that scales with an inner diameter of a conduit, inside which said turbine is installed for generating power, such that a clearance created between said inner sidewall of said conduit and an outermost surface of said turbine, when said turbine is installed in said conduit, ranges from about 0.5% to about 2% of said outermost diameter of said turbine.

17. The turbine of claim 16, wherein said clearance between said inner sidewall of said conduit and said outermost surface of said turbine is between about 0.5% and about 1% of said outermost diameter of said turbine.

18. A power generating system that generates power from the movement of fluids, the system comprising:
a turbine including:
a central longitudinal shaft configured to mount and to rotate on a central axis perpendicular to a direction of fluid flow;
a plurality of arcing blades coupled with said shaft, said blades extending radially outwardly from the shaft, and said blades including an airfoil cross-section along a substantial length of said blades; and
a hydrodynamic cap covering a location where said arcing blades couple with said shaft such that in an operating state of said turbine, presence of said hydrodynamic cap forces a larger amount of liquid to flow through an equator region of said turbine than if said hydrodynamic cap was absent; and
a generator operatively coupled with said shaft such that when fluid flows through said turbine, said blades and said shaft rotate around said central axis causing said generator to produce electricity.

19. The power generating system of claim 18, wherein said generator provides an increase in power efficiency that is less than or equal to about 30% in the presence of said hydrodynamic cap, as opposed to when said hydrodynamic cap is absent.

20. A process for manufacturing a power generating system customized for an application, said process comprising:
obtaining a power requirement for said application;
determining dimensions of a turbine or a hydrodynamic cap that reduce a fluid bypass area and are capable of providing said power requirement for said application;
coupling a plurality of blades and a shaft to form a turbine having said dimensions;
installing said turbine system in a conduit; and
operatively coupling a generator subassembly to said turbine system and producing said power generating system.

21. The process of claim 20, wherein said determining includes referring to a lookup table, which contains various values for dimensions of said turbine or of said hydrodynamic cap that correlate to values of power requirements.

22. The process of claim 20, further comprising:
obtaining a hydrodynamic cap of said dimensions; and
assembling said hydrodynamic cap and said turbine to form a turbine system.
